(19) United States
(12) Patent Application Publication
(10) Pub. No.: US 2020/0184412 A1
(43) Pub. Date: Jun. 11, 2020

(54) TECHNIQUES FOR IDENTIFYING TRAILERS ASSOCIATED WITH A TRACTOR USING WIRELESS SIGNALS

(71) Applicant: Omnitracs, LLC, Dallas, TX (US)

(72) Inventor: Jeffrey A CHAMPA, Heath, TX (US)

(21) Appl. No.: 16/707,939

(22) Filed: Dec. 9, 2019

Related U.S. Application Data
(60) Provisional application No. 62/777,534, filed on Dec. 10, 2018.

(51) Int. Cl. G06Q 10/08; H04B 17/318; H04W 4/40; H04W 56/00; H04W 4/021

(52) U.S. Cl. CPC G06Q 10/0833; H04B 17/318; H04W 4/021; H04W 56/001; H04W 4/40

(57) ABSTRACT

The present disclosure generally relates to one or more improved systems for identifying trailer(s) associated with a tractor using wireless signals emitted from a plurality of wireless transmitters attached to one or more trailers. Such techniques are advantageous over current systems because of the lack of proprietary hardware requirements and the convenience of being able to readily identify trailers prior to physically attaching to the trailer. Specifically, the present disclosure uses a plurality of wireless transmitters (of any type, e.g., Bluetooth, Wi-Fi, etc.) that may be synchronized such that each transmitter may periodically transmit identification (ID) information associated with the trailer. A computer device, such as an in-cab telematics device and/or mobile device associated with the tractor, may receive and process signals from the plurality of transmitters in order to identify and locate the trailer.

### CLAIM OF PRIORITY UNDER 35 U.S.C. § 119

This application claims priority to U.S. Provisional Application Number 62/777,534 titled “TECHNIQUES FOR IDENTIFYING TRAILERS ASSOCIATED WITH A TRACTOR USING WIRELESS SIGNALS,” filed Dec. 10, 2018, which is assigned to the assignee hereof, and incorporated herein by reference in its entirety.

### BACKGROUND

Aspects of the present disclosure relate generally to wireless communications in the trucking industry, and more particularly to techniques for identifying trailers associated with a tractor using wireless signals emitted from a plurality of wireless transmitters attached to one or more trailers.

Nearly every good consumed by households and businesses, at some point, is transported on a truck. The vast majority of communities rely on trucks to routinely deliver all of their essential products necessary for basic existence. The dynamics of the trucking and shipping industry provide that a tractor may be connected and detached from different trailers. To this end, a shipper may load and secure freight on a trailer that is later picked up by a trucking carrier for transportation. In many instances, the trailer may be located in a facility (e.g., a yard) with many similar trailers also loaded to be shipped to various destinations.

Currently, it is a common occurrence in the industry for the carriers to pick-up the wrong trailer and begin driving. This may occur due to number of factors, including visually indistinguishable trailers being located in close proximity. In such situations, while a driver may believe he or she has attached the tractor to a correct trailer, such errors may be costly. For example, misidentification of a trailer to be picked up may result in carrier having to return back to the facility to switch to the correct trailer, thereby costing valuable resources such as fuel, lost hours of service (HOS) for the driver, and idle detention time for other carriers waiting for their load to return.

Conventional systems have attempted to address the above-identified problem by establishing a communication link between a tractor and a trailer using a wired connection between the physically connected tractor and trailer(s). In such systems, communications may be carried over a wired connection (e.g., an existing power line carrier (PCL) links) to identify the trailer once the tractor and trailer have been physically attached. However, implementation of such systems require the tractors and trailers to each be equipped with proprietary hardware to facilitate such communications. Ensuring that both the tractor and trailer are equipped with the proprietary PCL hardware may not always be feasible considering that different trucking carriers may be contracted to pick up loads from various shippers. Additionally, as noted above, such systems require the tractor and trailer to first be physically attached prior to being able to identify the trailer based on signals carried over the wired connection. This may be inconvenient and time consuming if the tractor has to be repeatedly attached to and detached from multiple trailers prior to ensuring that the correct trailer has been picked up.

### SUMMARY

Aspects of the present disclosure provide techniques for identifying trailer(s) associated with a tractor using wireless signals emitted from a plurality of wireless transmitters attached to one or more trailers. Such techniques are advantageous over current systems because of the lack of proprietary hardware requirements and the convenience of being able to readily identify trailers prior to physically attaching to the trailer. Specifically, features of the present disclosure may use two or more wireless transmitters (e.g., Bluetooth, or Wi-Fi, etc.) attached to the trailer such that each transmitter may periodically transmit identification (ID) information associated with the trailer. A computer device, such as an in-cab telematics device and/or mobile device (e.g., wireless communications device) associated with the tractor, may receive and process the two or more signals from the transmitters in order to identify the trailer, where the use of the two or more signals help to distinguish the trailer over other trailers that may be nearby.

In one example, a method, an apparatus, and a computer readable medium for wireless communications associated with trucking. The method comprising receiving, at a computer device, a first signal associated with a first wireless transmitter attached to a trailer, wherein the computer device is located at a position associated with a tractor. The method may further comprise receiving, at the computer device, a second signal associated with a second wireless transmitter attached to the trailer, wherein the first wireless transmitter and the second wireless transmitter are synchronized. The method may further comprise determining received signal strength levels of the first signal and the second signal. The method may further comprise identifying, at the computer device, a trailer associated with the first wireless transmitter and the second wireless transmitter based on the received signal strength levels, prior to the tractor physically attaching to the trailer.

The above presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the present disclosure in a simplified form as a prelude to the more detailed description that is presented later.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional element or action, and in which:

FIGS. 1A and 1B are a schematic diagram of example scenario of detecting and identifying trailers based on wireless signals in accordance with aspects of the present disclosure;

FIG. 2 is a functional block diagram of example elements of a system in accordance with various aspects of the present disclosure;

FIG. 3 is a flowchart of an example method for identifying trailers based on received signal strength levels of wireless signals in accordance with various aspects of the present disclosure; and

FIG. 4 is a block diagram of an example of a computer device, including a mobile device and/or an electronic logging device (ELD), in accordance with the present disclosure.

### DETAILED DESCRIPTION

As discussed above, it is a common occurrence in the trucking industry for carriers to pick-up a wrong trailer from a loading yard, resulting in wasted valuable resources such as fuel, lost HOS for the driver, and time. Such errors may occur due to visually indistinguishable trailers being located in close proximity to one another. For example, a loading yard may include hundreds of trailers that may be scheduled for pickup by various carriers. Thus, while a driver may be provided with general information such as description of the area and trailer that is to be picked up, in reality there may be multiple similarly situated trailers. As such, there is a high likelihood that a driver may erroneously attach the tractor to the wrong trailer and begin driving.

Carriers have attempted to address the above-identified problem by using a wired connection between the physically connected tractor and trailer(s) in order to detect and identify the trailer ID. In such systems, communications may be carried over a wired connection (e.g., an existing power line carrier (PLC) links) to identify the trailer once the tractor and trailer have been physically attached. However, implementation of such systems require the tractors and trailers to each be equipped with proprietary hardware to facilitate such communications. Ensuring that both the tractor and trailer are equipped with the proprietary PLC hardware may not always be feasible considering that different trucking carriers may be contracted to pick up loads from various shippers. Additionally, as noted above, such systems require the tractor and trailer to first be physically attached prior to being able to identify the trailer based on signals modulated over the wired connection. This may be inconvenient and inefficient if the tractor has to be repeatedly attached to and detached from multiple trailers prior to ensuring that the correct trailer has been picked up.

Aspects of the present disclosure provide techniques for identifying trailer(s) associated with a tractor using wireless signals emitted from a plurality of wireless transmitters attached to one or more trailers. Such techniques are advantageous over current systems because of the lack of proprietary hardware requirements and the convenience of being able to readily identify trailers prior to physically attaching to the trailer. Additionally, features of the present disclosure allow the in-cab hardware (e.g., mobile device) to be flexibly interchangeable as opposed to requiring a proprietary hardware for each vendor.

Specifically, features of the present disclosure use a plurality of wireless transmitters (of any type, e.g., Bluetooth, or Wi-Fi, etc.) that may be located on the trailer, e.g., attached to the nose of the trailer, such that each transmitter may periodically transmit ID information associated with the trailer. In some cases, the signals from the plurality of wireless transmitters on each trailer may be synchronized, e.g., with respect to information sent and/or transmission timing, to aid in identifying and locating the trailer. A computer device, including an in-cab telematics device and/or a mobile device associated with the tractor, may receive and process signals from the plurality of transmitters in order to identify the trailer, where the use of the plurality of signals from the plurality of transmitters help to distinguish the trailer over other trailers that may be located in the same vicinity.

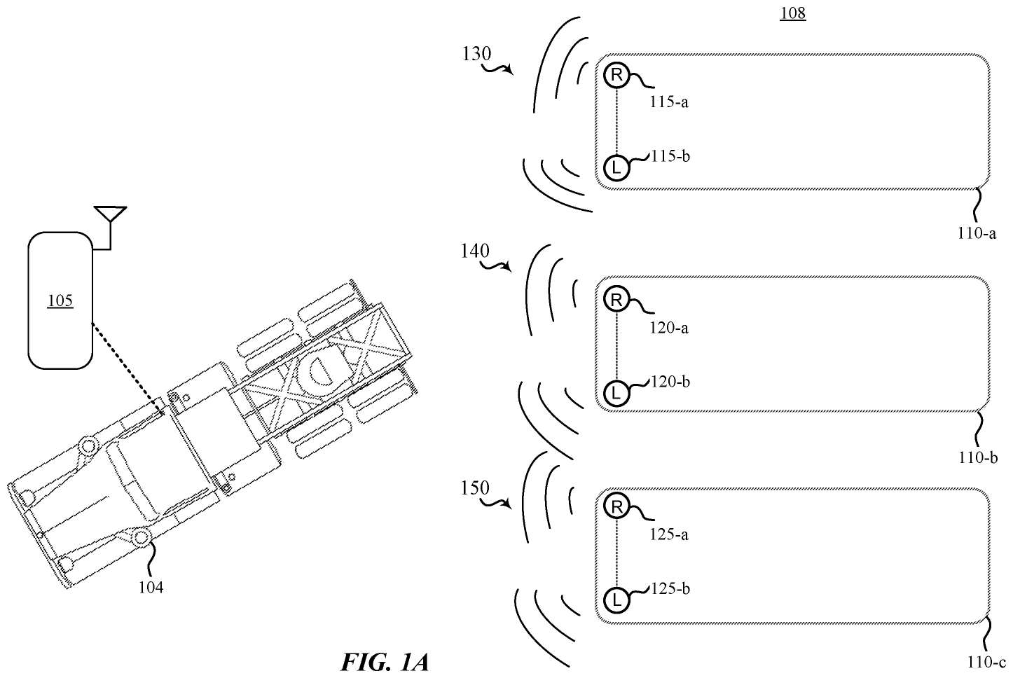

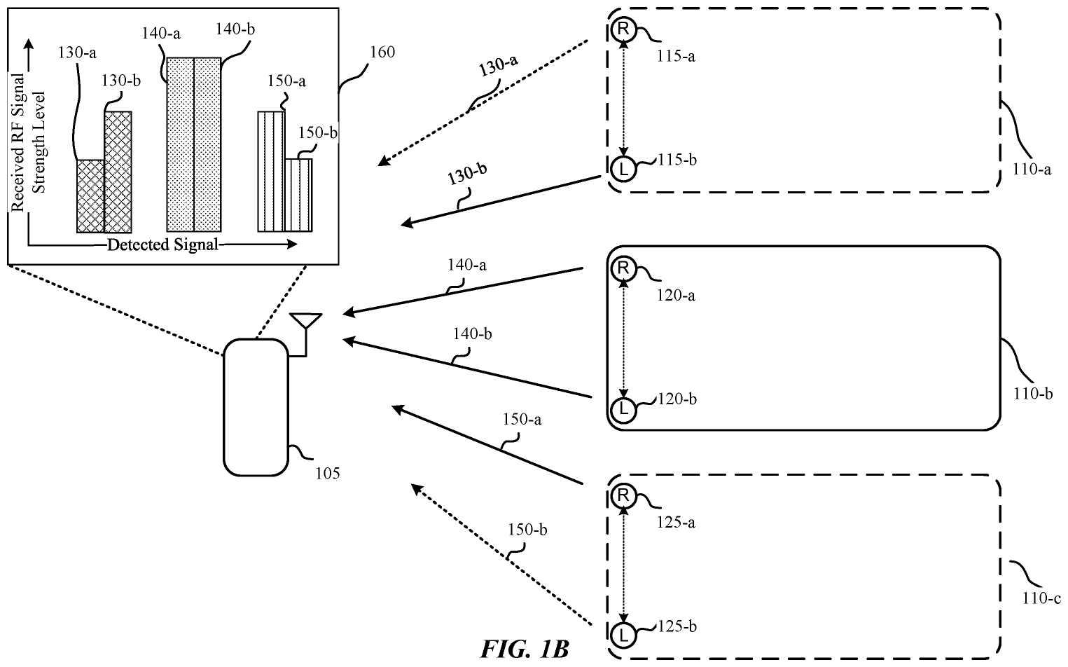

Various aspects are now described in more detail with reference to the FIGS. 1-4. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples of implementations of the described system based on the principles described herein, but it should be understood that these examples are not intended to limit the scope of the claims. For instance, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined with other features described in other examples.

FIGS. 1A and 1B, discussed concurrently here, include one example of a system 100 for implementing techniques for identifying trailer(s) 110 associated with a tractor 104 using wireless signals emitted from a plurality of wireless transmitters (e.g., wireless transmitters 115-a and -b, 120-a and -b, 125-a and -b) attached to one or more trailers 110. In some examples, the tractor 104 may include or may operate in association with a computer device 105. In some examples, the computer device 105 may be or may include a smart phone, a tablet, an telematics device, an electronic logging device (ELD), or a laptop located inside or outside (e.g., carried by the driver) the tractor 104.

As noted above, for example, one or more trailers 110 (e.g., first trailer 110-a, second trailer 110-b, third trailer 110-c, etc.) may be parked in a loading yard 108, and one of the trailers may be scheduled to be picked up by the tractor 104 for transportation to a delivery location. For instance, the shipping customer or fleet manager may assign a driver of the tractor 104 to pick up the first trailer 110-a from the loading yard 108. However, due to similarly situated trailers 110 (e.g., first trailer 110-a, second trailer 110-b, third trailer 110-c, etc.) in the loading yard 108, it may be difficult for the driver to identify the correct trailer (e.g., first trailer 110-a) from the plurality of trailers 110 (e.g., second trailer 110-b, third trailer 110-c, etc.).

To this end, features of the present disclosure provide techniques for identifying trailer(s) 110 assigned to the tractor 104 using wireless signals (e.g., signals 130, 140, 150 in FIG. 1A, more specifically signals 130-a and -b, 140-a and -b, 150-a and -b in FIG. 1B) emitted from a plurality of wireless transmitters attached to the trailers 110. In some examples, each wireless transmitter (e.g., wireless transmitters 115, 120, 125) may be synchronized, including being paired (e.g., via Bluetooth pairing), with at least one additional wireless transmitter that is located on trailer 110, which may allow each synchronized set of transmitters to send related signals that help to identify and/or locate the trailer. As used here, synchronized means that the signals may contain the same, similar, and/or overlapping information, and/or that the signals have a predetermined timing with respect to one another.

For example, the first trailer 110-a may include a first wireless transmitter 115-a and a second wireless transmitter 115-b that are synchronized. Similarly, the second trailer 110-b may include a first wireless transmitter 120-a and a second wireless transmitter 120-b that are synchronized. Finally, the third trailer 110-c may include a first wireless transmitter 125-a and a second wireless transmitter 125-b that are synchronized. Within each synchronized set of the wireless transmitters, one wireless transmitter (e.g., first wireless transmitter 115-a) may function as a master device while the other wireless transmitter (e.g., second wireless transmitter 115-b) may function as a slave device.

Continuing with the example, each wireless transmitter (e.g., wireless transmitters 115, 120, 125) associated with each trailer 110 in the loading yard 108 may periodically transmit a signal (e.g., a chirp signal) to advertise the ID of the trailer 110, in addition to synchronization information such as the ID of the wireless transmitter itself and the ID of the one or more other synchronized wireless transmitter. Additionally or alternatively, each wireless transmitter may advertise its relevant orientation with respect to the position on the trailer 110. For example, with respect to the first trailer 110-a, the first wireless transmitter 115-a may advertise its position on the right nose of the first trailer 110-a, while a second wireless transmitter 115-b may advertise its position as being located on the left nose of the first trailer 110-b. Similarly, with respect to the second trailer 110-b, the first wireless transmitter 120-a may advertise its position on the right nose of the second trailer 110-a, while a second wireless transmitter 120-b may advertise its position as being located on the left nose of the second trailer 110-b.

Further with regard to the example, because of the synchronization, the signals from each of the paired wireless transmitters may be ordered in time. For example, once the first wireless transmitter 115-a, as a master device, transmits a first signal, the second wireless transmitter 115-b, as a slave device, may receive and recognize the signal from the master, which may trigger the slave device to also transmit its own synchronized signal including, e.g., the ID of the trailer, the ID of the slave wireless transmitter, and the ID of the master transmitter, etc.

The computer device 105 associated with the tractor 104, which may be backing in to attach to the trailer 110, may receive signals from each of the wireless transmitters from each trailer 110 that may be in close proximity. To this end, the computer device 105 may decipher the received signals to identify the trailer ID of the trailer 110 that may be directly behind the tractor 104 based on the received signal strength levels of various signals, and the corresponding position and orientation of the wireless transmitter that is transmitting the signal.

For example, referring to FIG. 1B, the computer device 105 may receive signals (e.g., signals 130-a and -b, 140-a and -b, 150-a and -b) from each wireless transmitter (e.g., wireless transmitters 115-a and -b, 120-a and -b, 125-a and -b). Based on the location of the computer device 105 relative to the tractor 104, the received signal strength level of the signals from the wireless transmitters directly behind the tractor 104 may have a higher value than the comparative received signal strength level of the signals from trailers slightly further away, as illustrated in graph 160. Thus, the mobile device 104 may compare the received signal strength levels of each received signal, or each set of synchronized signals, to identify the trailer ID associated with the trailer 110 that may be located directly behind the tractor 104. Additionally, given that each wireless transmitter (e.g., wireless transmitters 115-a and -b, 120-a and -b, 125-a and -b) may also advertise its position and/or orientation (e.g., front left versus front right) with respect to its respective trailer 110 (e.g., 110-a, 110-b, and 110-c), the computer device 105 may distinguish the received signals having similar received signal strength levels as originating from different trailers (e.g., second signal 130-b from left positioned second wireless transmitter 115-b may be distinguished from the first signal 140-a from the right positioned first wireless transmitter 115-a). Thus, in accordance with features of the present disclosure, the combination of closely associated synchronized or paired received signal strength levels in addition to the position and orientation of the wireless transmitters may inform the computer device 105 of the ID of the trailer that may be located directly behind the tractor 104. In the scenario of FIGS. 1A and 1B, in a case where the driver of the tractor 104 has been instructed to pick-up the first trailer 110-a, the computer device 105 may be configured to detect that the second trailer 110-b that is directly behind the tractor 104 is the wrong trailer, and thus allows the driver to take corrective measures of re-orienting the tractor 104 to pick up the first trailer 110-a without the need to first physically connect with any trailer.

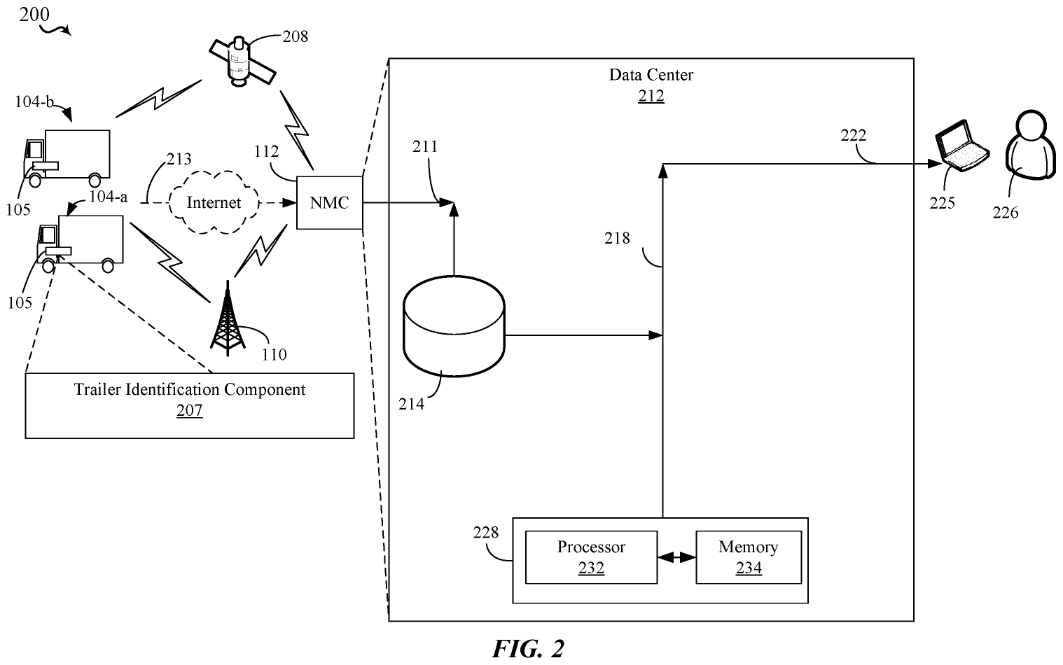

Referring to FIG. 2, in an aspect, a system 200 includes one or more modules and components for identifying trailers associated with wireless transmitters. As used herein, the terms “module(s),” or “components” may be one of the parts that make up a device, may be hardware or software or firmware, and may be divided into other modules and/or distributed across one or more processors.

In an aspect, system 200 can comprise a network management center (NMC) 112 configured to communicate with one or more vehicles 104 via the computer device 105 (e.g., ELD and/or mobile device, etc.) located on each tractor 104 or associated with each driver of each tractor 104. In some systems, the computer device 105 may be more than one device, such as an ELD that may communicate with the mobile device (e.g., a smart phone or an in-cab telematics device). The system 200 may include one or more fleets of vehicles 104, each fleet having at least one tractor 104. Typically, a fleet could include many tens, hundreds or thousands of vehicles. An example fleet is illustrated as having two vehicles 104. Each computer device 105 may include ELD functionality configured to collect and transmit data associated with the driver and/or the operation of the tractor 104 to the NMC 112. Also, in some implementations, each computer device 105 and/or its ELD functionality can be configured to perform calculations associated with one or more fleet using any of the collected data.

In an example implementation, the one or more vehicles 104 may be equipped with the computer device 105 in the form of a mobile device in communication with a separate ELD, where the mobile device may function as an in-cab telematics device. In some instances, the mobile device may be a smart phone or tablet configured to receive and process signals and information. In some instances, the ELD may be in communication with the mobile device to allow the collected information to be displayed on the mobile device. To this end, the computer device 105 in the form of either the ELD or the mobile device may include a trailer identification component 207 to perform one or more functions of the present disclosure.

For example, the trailer identification component 207 may implement techniques for identifying trailer(s) associated with a tractor using wireless signals emitted from a plurality of wireless transmitters attached to one or more trailers. Specifically, the trailer identification component 207 may use a plurality of wireless transmitters (of any type, e.g., Bluetooth, Wi-Fi, etc.) that may be synchronized and attached to the trailer such that each transmitter may periodically transmit ID information associated with the trailer. An in-cab telematics device (e.g., mobile device) included in the tractor may receive and process signals from the plurality of transmitters in order to identify the trailer. In an aspect, trailer identification component 207 may be implemented as a software application defined by code or instructions stored in a computer-readable medium and executed by a processor, and/or as hardware (e.g., a specially programmed processor module), and/or as firmware.

In some implementations, the computer device 105 may include a processor configured to execute one or more trailer identification component 207 and establish communication with external devices, such as NMC 112, via a communication network (e.g., a terrestrial or satellite-based wireless network). The computer device 105 may also include a memory configured to store computer-readable code that may define all or part of the trailer identification component 207 and also to store data associated with the components and/or computer device 105. The computer device 105 may also include a user interface or display, a mobile application server, and a communications module (e.g., including the one or more transceivers, and one or more of terrestrial and Wi-Fi modems, one or more antennae, a GPS module, and a satellite communications module).

As an example only, each tractor 104 may be in bi-directional communication via the computer device 105 with NMC 112 over at least one communication channel. In the example shown in FIG. 2, each tractor 104 is in bi-directional communication with the NMC 112 over at least one of a satellite-based communication system 208 or a terrestrial-based system 110 (e.g., a wireless communication system using a communication protocol/technology such as, but not limited to, 5G or New Radio, GSM, CDMA, TDMA, WCDMA, EDGE, OFDM, GPRS, EV-DO, LTE, WiFi, Bluetooth), or, when the vehicle is stopped, via a wired connection 213 through the Internet. Depending on many factors, data may be exchanged with the vehicles 104 using one or both of the satellite communication system 208 and the terrestrial-based communication system 110.

In an aspect, many different types of data are collected and transferred from the vehicles 104 to the NMC 112. Examples of such data include, but are not limited to, vehicle performance data, driver performance data, critical events, messaging and position data, location delivery data, and many other types of data. All of the information that is communicated to and from the vehicles 104 may be processed via the NMC 112. The NMC 112 can be thought of as a data clearinghouse that receives all data that is transmitted to and received from the vehicles 104. Moreover, in an aspect, NMC 112 may include one or more back-end servers. Thus, in some aspects, the collected information may periodically (e.g., every x minutes, where x is a whole number, or once a day, or upon availability of a wired or wireless connection) be transmitted from the computer device 105 to the NMC 112 for analysis and record keeping.

The system 200 also includes a data center 212, which may be part of or in communication with NMC 112. The data center 212 illustrates one possible implementation of a central repository for all of the data received from each of the vehicles 104. As an example, as mentioned above many different types of data are transmitted from the computer devices 105 associated with each of the vehicles 104 to the NMC 112. In the case where data center 212 is in communication with NMC 112, the data may be transmitted via connection 211 to the data center 212. The connection 211 may comprise any wired or wireless dedicated connection, a broadband connection, or any other communication channel configured to transport the data. Moreover, in an aspect, data center 212 may include one or more back-end servers analyzing the one or more parameters transmitted from the one or more computer devices 105. Additionally or alternatively, data may also be exchanged between the plurality of computer devices 105 using, for example, peer-to-peer (P2P) communication without the involvement of the NMC 112.

In an aspect, the data center 212 may include a data warehouse 214 for receiving the data from the computer device 105 relating to the tractor 104. In an aspect, for example, data center 212 may include any number of application servers and data stores, where each may be associated with a separate fleet and/or driver management or performance data. In an aspect, each application server and data store may include a processor, memory including volatile and non-volatile memory, specially-programmed operational software, a communication bus, an input/output mechanism, and other operational systems. For example, an application server may be a services portal (SP) server that receives, for example, messaging and positioning (M/P) data from each of the vehicles 104. Another application server, for example only, may include one or more servers related to safety and compliance, such as a quick deployment center (QDC) server that receives, for example, critical event (CE) data from each of the vehicles 104. Further, for example, another application server may be vehicle and driver performance data related to fuel usage and/or cost from each of the vehicles 104. It should be understood that the above list of example servers is for illustrative purposes only, and data center 212 may include additional and/or different application servers.

In some aspect, the trailer identification component 207 may further communicate with a terminal device 225, which can be a user interface portal, a web-based interface, a personal computer (PC), a laptop, a personal data assistant (PDA), a smart phone, a dedicated terminal, a dumb terminal, or any other device over which a user 226, such as a manager or operator responsible for monitoring a fleet of vehicles 104, may communicate.

In an aspect, the data center 212 may include an analysis engine 228 to analyze the data received from the computer device 105. The analysis engine 228 includes a processor 232 and a memory 234 the respectively execute and store instructions and data associated the operation of the data center 212. Although shown as residing within the data center 212, the analysis engine 228 may reside elsewhere, and may be implemented as a distributed system in which the processor 232 and the memory 234 may include one or more processor and memories, and may be located in different places, such as at NMC 112 and/or one or more servers associated with NMC 112 or data center 212.

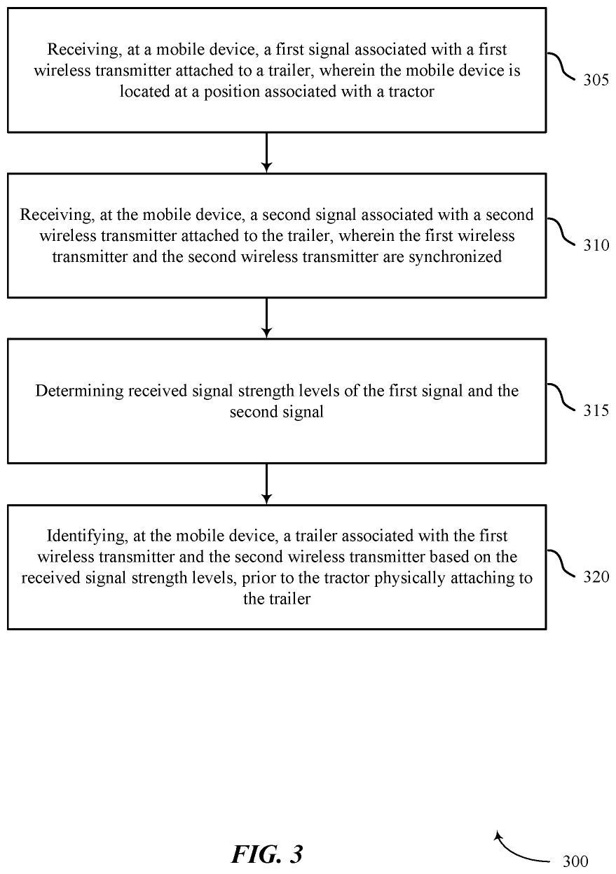

FIG. 3 illustrates one example of a method 300 of wireless communications associated with trucking in accordance with various aspects of the present disclosure. The method 300 may be performed by the computer device 105, including either or both of a mobile device and/or ELD associated with or included within the cab of the tractor 104. For purposes of the present disclosure, the term “mobile device” is used broadly to encompass stand-alone smart phone, tablet devices in addition to the ELD that may be included within the tractor 104.

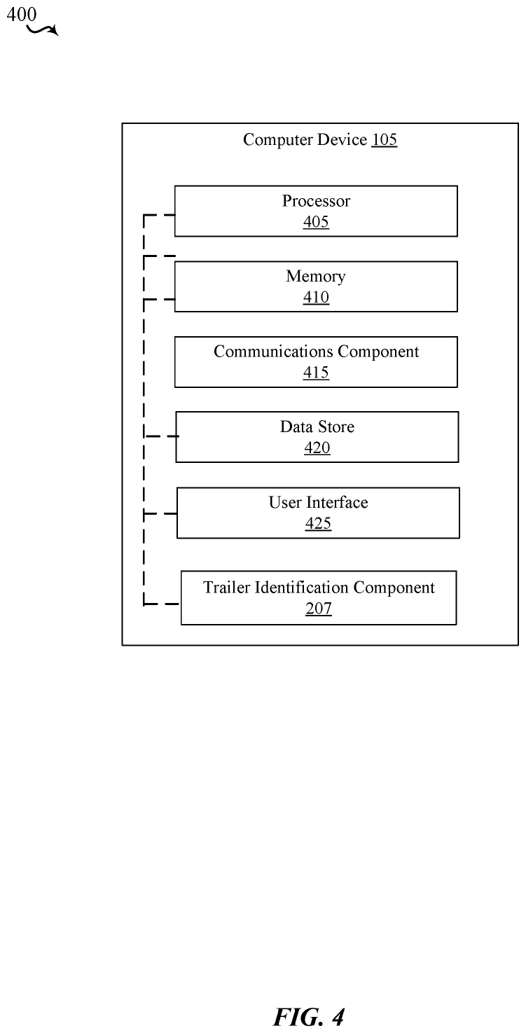

At block 305, the method 300 may include receiving, at a computer device, a first signal associated with a first wireless transmitter attached to a trailer, wherein the computer device is located at a position associated with a tractor. For example, the computer device may be located on or within a cab of the tractor, or may be located near the tractor (e.g., held by a person in, on, or near the tractor). In some examples, the first signal may identify a physical orientation of the first wireless transmitter with respect to the trailer. Aspects of block 305 may be performed by communications component 415 described with reference to FIG. 4.

At block 310, the method 300 may include receiving, at the computer device, a second signal associated with a second wireless transmitter attached to the trailer, wherein the first wireless transmitter and the second wireless transmitter are synchronized. Thus, in some examples, the first signal (and the second signal) may include identification information associated with the first wireless transmitter and the second wireless transmitter that is synchronized with first wireless transmitter. In some cases, each wireless transmitter may transmit identification information associated with itself in addition to the ID associated with the synchronized wireless transmitter. Aspects of block 310 may also be performed by communications component 415 described with reference to FIG. 4.

At block 315, the method 300 may include determining received signal strength levels of the first signal and the second signal. Aspects of block 315 may be performed by trailer identification component 207 described with reference to FIG. 4. The respective received signal strength levels may identify a first physical orientation of the first wireless transmitter and a second physical orientation of the second wireless transmitter relative to the computing device 105, and hence relative to the tractor 104.

At block 320, the method 300 may include identifying, at the computer device, a trailer associated with the first wireless transmitter and the second wireless transmitter based on the received signal strength levels, prior to the tractor physically attaching to the trailer. In some examples, identifying the trailer associated with the first wireless transmitter and the second wireless transmitter may comprise determining, based on the received signal strength levels, whether the first physical orientation of the first wireless transmitter and the second physical orientation of the second wireless transmitter aligns with a position of the trailer being near the tractor. Aspects of block 320 may also be performed by trailer identification component 207 described with reference to FIG. 4.

The identifying may include providing one or more indications, via the computer device 105, indicating whether the trailer 110 behind the tractor 104 is the trailer 110 the tractor 104 is supposed to couple with or not. The indications may be an audio, visual or a combination of audio and visual indications. For example, a first audio indication may indicate that the trailer 110 is the trailer 110 the tractor 105 is supposed to couple with and a second audio indication may indicate that the trailer 110 is not the trailer 110. The indications may be based on whether the ID information from the trailer 110 matches the ID information for the trailer 110 the tractor 104 is supposed to couple with. The first audio indication and the second audio indication are different. Similarly, a first visual indication may be displayed on the computer device 105 indicating that the trailer 110 is the trailer 110 the tractor 105 is supposed to couple with and a second visual indication indicating that the trailer 110 is not the trailer 110 the tractor 104 is supposed to couple with. For example, the first visual indication may be a green screen, a green object, a check or another visual indication indicating that the trailer 110 is the trailer 110 the tractor 105 is supposed to couple with. Conversely, the second visual indication may be a red screen, a red object, an “X” or another visual indication indicating that the trailer 110 is not the trailer 110 the tractor is supposed to couple with. The first visual indication and the second indication are different. In another example, the ID information for the identified trailer may be displayed on the computer device 105. For example, the ID information for the trailer 110 is displayed on the computer device 105. In another example, if the trailer 110 is the trailer 110 the tractor 105 is supposed to couple with, the ID information is displayed in green and if the trailer 110 is not the trailer 110, the ID information is displayed in red.

Referring to FIG. 4, in an example that should not be construed as limiting, the computer device 105, including a mobile device and/or ELD, may include additional components that operate in conjunction with trailer identification component 207 and may be implemented in specially programmed computer readable instructions or code, firmware, hardware, or some combination thereof.

In an aspect, for example, features described herein with respect to the functions of trailer identification component 207 may be implemented in or executed using one or any combination of processor 405, memory 410, communications module 415, and data store 420. For example, trailer identification component 207 may be defined or otherwise programmed as one or more processor modules of processor 405. Further, for example, trailer identification component 207 may be defined as a computer-readable medium (e.g., a non-transitory computer-readable medium) stored in memory 410 and/or data store 420 and executed by processor 405. Moreover, for example, inputs and outputs relating to operations of trailer identification component 207 may be provided or supported by communications module 415, which may provide a bus between the modules of computer device or an interface for communication with external devices or modules.

Processor 405 can include a single or multiple set of processors or multi-core processors. Moreover, processor 405 can be implemented as an integrated processing system and/or a distributed processing system. Memory 410 may operate to allow storing and retrieval of data used herein and/or local versions of applications and/or software and/or instructions or code being executed by processor 405, such as to perform the respective functions of trailer identification component 207 described herein. Memory 410 can include any type of memory usable by a computer, such as random access memory (RAM), read only memory (ROM), tapes, magnetic discs, optical discs, volatile memory, non-volatile memory, and any combination thereof.

Communications module 415 is operable to establish and maintain communications with one or more internal components/modules or external devices utilizing hardware, software, and services as described herein. Communications component 415 may carry communications between modules on computer device 105, as well as between user and external devices, such as devices located across a communications network and/or devices serially or locally connected to computer device 105. For example, communications component 415 may include one or more buses, and may further include transmit chain modules and receive chain modules associated with a transmitter and receiver, respectively, or a transceiver, operable for interfacing with external devices.

Additionally, data store 420, which can be any suitable combination of hardware and/or software, which provides for mass storage of information, databases, and programs employed in connection with aspects described herein. For example, data store 420 may be a data repository for applications not currently being executed by processor 405.

The computer device 105 may additionally include a user interface module 425 operable to receive inputs from a user, and further operable to generate outputs for presentation to the user. User interface module 425 may include one or more input devices, including but not limited to a keyboard, a number pad, a mouse, a touch-sensitive display, a navigation key, a function key, a microphone, a voice recognition module, any other mechanism capable of receiving an input from a user, or any combination thereof. Further, user interface module 425 may include one or more output devices, including but not limited to a display, a speaker, a haptic feedback mechanism, a printer, any other mechanism capable of presenting an output to a user, or any combination thereof.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. 1-4 which may illustrate various process flows.

As used in this description, the terms “module,” “components,” “database,” “module,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device may be a module. One or more modules may reside within a process and/or thread of execution, and a module may be localized on one computer and/or distributed between two or more computers. In addition, these modules may execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blue-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for wireless communications associated with trucking, comprising:
receiving, at a computer device, a first signal associated with a first wireless transmitter attached to a trailer, wherein the computer device is located at a position associated with a tractor;
receiving, at the computer device, a second signal associated with a second wireless transmitter attached to the trailer, wherein the first wireless transmitter and the second wireless transmitter are synchronized;
determining received signal strength levels of the first signal and the second signal; and
identifying, at the computer device, a trailer associated with the first wireless transmitter and the second wireless transmitter based on the received signal strength levels, prior to the tractor physically attaching to the trailer.

2. The method of claim 1, wherein the first signal includes identification information associated with the first wireless transmitter and the second wireless transmitter that is synchronized with first wireless transmitter.

3. The method of claim 1, wherein the first signal identifies a first physical orientation of the first wireless transmitter with respect to the trailer, and
wherein the second signal identifies a second physical orientation of the second wireless transmitter with respect to the trailer.

4. The method of claim 3, wherein identifying the trailer associated with the first wireless transmitter and the second wireless transmitter further comprises:
determining, based on the received signal strength levels, whether the first physical orientation of the first wireless transmitter and the second physical orientation of the second wireless transmitter aligns with a position of the trailer being near the tractor.

5. The method of claim 1, wherein the first signal and the second signal comprise at least one of same information, overlapping information or signals having predetermined timing with respect to one another.

6. The method of claim 5, wherein the same information comprises identification information identifying the trailer.

7. A computer device for wireless communications associated with trucking, comprising:
a memory configured to store instructions;
a processor communicatively coupled with the memory, the processor configured to executed the instructions to:
receive a first signal associated with a first wireless transmitter attached to a trailer, wherein the computer device is located at a position associated with a tractor;
receive a second signal associated with a second wireless transmitter attached to the trailer, wherein the first wireless transmitter and the second wireless transmitter are synchronized;
determine received signal strength levels of the first signal and the second signal; and
identify a trailer associated with the first wireless transmitter and the second wireless transmitter based on the received signal strength levels, prior to the tractor physically attaching to the trailer.

8. The computer device of claim 7, wherein the first signal includes identification information associated with the first wireless transmitter and the second wireless transmitter that is synchronized with first wireless transmitter.

9. The computer device of claim 7, wherein the first signal identifies a first physical orientation of the first wireless transmitter with respect to the trailer, and
wherein the second signal identifies a second physical orientation of the second wireless transmitter with respect to the trailer.

10. The computer device of claim 9, wherein identifying the trailer associated with the first wireless transmitter and the second wireless transmitter further comprises:
determining, based on the received signal strength levels, whether the first physical orientation of the first wireless transmitter and the second physical orientation of the second wireless transmitter aligns with a position of the trailer being near the tractor.

11. The computer device of claim 7, wherein the first signal and the second signal comprise at least one of same information, overlapping information or signals having predetermined timing with respect to one another.

12. The computer device of claim 11, wherein the same information comprises identification information identifying the trailer.

13. A non-transitory computer readable medium storing instructions, executable by a processor of a computer device for wireless communications associated with trucking, comprising instructions for:
receiving a first signal associated with a first wireless transmitter attached to a trailer, wherein the computer device is located at a position associated with a tractor;
receiving a second signal associated with a second wireless transmitter attached to the trailer, wherein the first wireless transmitter and the second wireless transmitter are synchronized;
determining received signal strength levels of the first signal and the second signal; and
identifying a trailer associated with the first wireless transmitter and the second wireless transmitter based on the received signal strength levels, prior to the tractor physically attaching to the trailer.

14. The computer readable medium of claim 13, wherein the first signal includes identification information associated with the first wireless transmitter and the second wireless transmitter that is synchronized with first wireless transmitter.

15. The computer readable medium of claim 13, wherein the first signal identifies a first physical orientation of the first wireless transmitter with respect to the trailer, and
wherein the second signal identifies a second physical orientation of the second wireless transmitter with respect to the trailer.

16. The computer readable medium of claim 15, wherein identifying the trailer associated with the first wireless transmitter and the second wireless transmitter further comprises:
determining, based on the received signal strength levels, whether the first physical orientation of the first wireless transmitter and the second physical orientation of the second wireless transmitter aligns with a position of the trailer being near the tractor.

17. The computer readable medium of claim 13, wherein the first signal and the second signal comprise at least one of same information, overlapping information or signals having predetermined timing with respect to one another.

18. The computer readable medium of claim 17, wherein the same information comprises identification information identifying the trailer.
